(19) United States
(12) Patent Application Publication
(10) Pub. No.: US 2014/0174133 A1
(43) Pub. Date: Jun. 26, 2014

(54) METHODS FOR FORMING OPTICAL FIBER PREFORMS WITH SELECTIVE DIFFUSION LAYERS

(71) Applicants: Amanda Lee Billings, Wilmington, NC (US); Liam Ruan de Paor, Hampstead, NC (US); Robert Brett Desorcie, Painted Post, NY (US); Robert Arnold Knowlton, Wellsboro, PA (US); Pushkar Tandon, Painted Post, NY (US)

(72) Inventors: Amanda Lee Billings, Wilmington, NC (US); Liam Ruan de Paor, Hampstead, NC (US); Robert Brett Desorcie, Painted Post, NY (US); Robert Arnold Knowlton, Wellsboro, PA (US); Pushkar Tandon, Painted Post, NY (US)

(73) Assignee: Corning Incorporated, Corning, NY (US)

(21) Appl. No.: 14/107,259

(22) Filed: Dec. 16, 2013

Related U.S. Application Data
(60) Provisional application No. 61/739,958, filed on Dec. 20, 2012.

(51) Int. Cl. C03B 37/014; G02B 6/036

(52) U.S. Cl. CPC C03B 37/01446; C03B 37/014; C03B 37/01453; G02B 6/036
USPC 65/397; 65/399; 65/421; 65/422

(57) ABSTRACT

Methods for forming optical fiber preforms are disclosed. According to one embodiment, a method for forming an optical fiber preform includes forming a preform core portion from silica-based glass soot. The silica-based glass soot may include at least one dopant species for altering an index of refraction of the preform core portion. A selective diffusion layer of silica-based glass soot may be formed around the preform core portion to form a soot preform. The selective diffusion layer may have an as-formed density greater than the density of the preform core portion. A diffusing species may be diffused through the selective diffusion layer into the preform core portion. The soot preform may be sintered such that the selective diffusion layer has a barrier density which is greater than the as-formed density and the selective diffusion layer prevents diffusion of the at least one dopant species through the selective diffusion layer.

### CROSS-REFERENCE TO RELATED APPLICATIONS

This application claims the benefit of priority under 35 U.S.C. §119 of U.S. Provisional Application Ser. No. 61/739,958, filed on Dec. 20, 2012, the content of which is relied upon and incorporated herein by reference in its entirety.

### BACKGROUND

1. Field

The present specification generally relates to the manufacture of optical fibers and, more specifically, to methods for forming optical fiber preforms with selective diffusion layers to control the migration of dopants and/or processing agents.

2. Technical Background

In the manufacture of optical fiber various vapor deposition processes, such as outside vapor deposition (OVD) and vapor axial deposition (VAD) processes, may be used to produce an optical fiber preform from which optical fiber is subsequently drawn. To form the optical fiber preform from these vapor deposition processes, silica-based, pyrogenically-generated soot is deposited to form a soot preform. The soot preform is treated by one or more processing agents, such as a dehydration agent or the like, and then sintered into solid glass to form the preform. These agents may be introduced into the porous soot preform in a gas or vapor phase which diffuses through the pores of the preform and generally permeates throughout the volume of the preform. For example, chlorine may be introduced into the preform, either alone or entrained in a diluent gas, in order to remove water from within the preform. Accordingly, the manufacture of an optical fiber preform may require that the entire preform be permeable to certain processing agents to facilitate uniform treatment of the preform.

In addition, certain portions of the optical fiber preform are produced using doped silica soot such that the corresponding portion of the preform has a designed refractive index profile and the fiber drawn from the preform behaves as an effective waveguide for guiding light. However, during the sintering process, the dopants in certain areas of the optical fiber preform may volatilize and diffuse through the porous soot preform and away from the intended or designed deposition location. The volatilized dopants may then be re-deposited in regions of the preform where they are not intended, thereby altering the designed refractive index profile of the optical fiber. The re-deposition of the volatilized dopants can negatively impact the optical performance of the fiber.

Accordingly, a need exists for alternative methods of controlling the diffusion of processing agents and/or dopants during formation of an optical fiber preform.

### SUMMARY

According to one embodiment, a method for forming an optical fiber preform includes forming a preform core portion from silica-based glass soot such that the preform core portion has a preform core density. The silica-based glass soot may include at least one dopant species for altering an index of refraction of the preform core portion. A selective diffusion layer of silica-based glass soot may be formed around the preform core portion to form a soot preform comprising the preform core portion and the selective diffusion layer. The selective diffusion layer may have an as-formed density greater than the preform core density. At least one diffusing species may be diffused through the selective diffusion layer into the preform core portion. Thereafter, the soot preform may be sintered such that the selective diffusion layer has a barrier density which is greater than the as-formed density and the selective diffusion layer prevents diffusion of the at least one dopant species through the selective diffusion layer.

In another embodiment, a method for forming an optical fiber preform includes constructing a soot preform by forming a preform core portion and forming an inner cladding layer around the preform core portion. The inner cladding layer may have an inner cladding density. An outer selective diffusion layer may be formed around the inner cladding layer. The outer selective diffusion layer may have an outer as-formed density greater than the inner cladding density. An outer cladding layer may be deposited around the outer selective diffusion layer. The outer cladding layer may have an outer cladding density which is less than the outer as-formed density. At least one diffusing species may be diffused through the outer selective diffusion layer into the inner cladding layer. Thereafter, the soot preform may be sintered such that the outer selective diffusion layer has an outer barrier density greater than the outer as-formed density and the outer selective diffusion layer prevents diffusion of the at least one diffusing species through the outer selective diffusion layer.

Additional features and advantages of the methods described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a cross section of an optical fiber preform according to one or more embodiments shown and described herein;

FIG. 2 schematically depicts a cross section of an optical fiber preform according to another embodiment shown and described herein;

FIGS. 3A-3E schematically depict the formation of a soot preform according to one or more embodiments shown and described herein;

FIG. 4 schematically depicts the consolidation of the soot preform of FIG. 2, according to one embodiment shown and described herein; and

FIG. 5 graphically depicts the radius of optical fiber preforms from the centerline (x-axis); the GeO₂ concentration of the optical fiber preform (left y-axis) (a) prior to sintering, (b) after sintering without a selective diffusion layer, and (c) after sintering with a selective diffusion layer; and the density of the optical fiber preform with a selective diffusion layer (right y-axis) prior to sintering.

### DETAILED DESCRIPTION

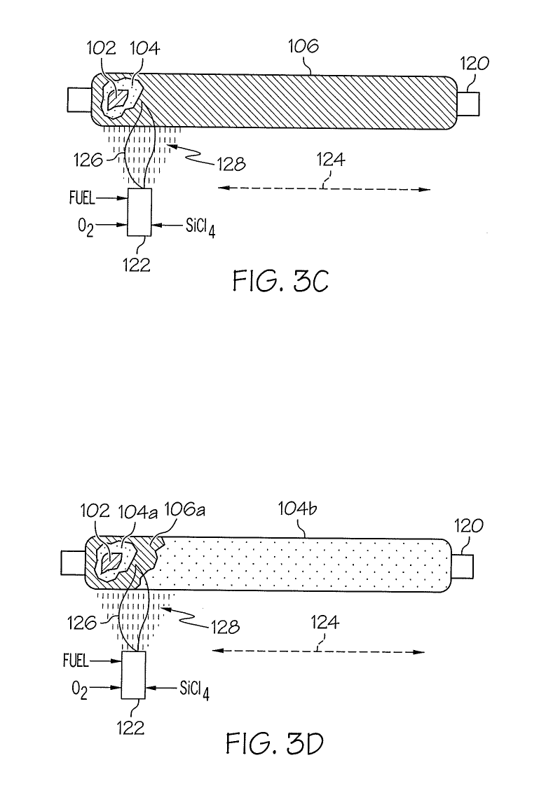

Reference will now be made in detail to embodiments of methods for forming optical fiber preforms with selective diffusion layers, examples of which are illustrated in the accompanying drawings. Whenever possible, the same reference numerals will be used throughout the drawings to refer to the same or like parts. One embodiment of the method for forming an optical fiber preform is schematically depicted in FIGS. 3A-3E. The method may generally include forming a preform core portion from silica-based glass soot such that the preform core portion has a preform core density. The silica-based glass soot comprises at least one dopant species for altering the index of refraction of the preform core portion. A selective diffusion layer of silica-based glass soot may be deposited around the preform core portion to form a soot preform comprising the core portion and the selective diffusion layer. The selective diffusion layer has an as-formed density greater than the preform core density. The phrase “as-formed density” refers to the density of the selective diffusion layer prior to exposure to any processes (such as sintering or the like) which increase the density of the selective diffusion layer. At least one diffusing species may be diffused through the selective diffusion layer into the preform core portion. Thereafter, the preform assembly is sintered such that the selective diffusion layer has a barrier density which is greater than the as-formed density and the selective diffusion layer prevents diffusion of the at least one dopant species through the selective diffusion layer. Various embodiments of methods of forming soot preforms with selective diffusion layers will be described in more detail herein with specific reference to the appended figures.

The following terminology will be used herein to described the soot preforms and optical fiber preforms formed therefrom:

The term “refractive index profile,” as used herein, is the relationship between the refractive index or the relative refractive index and the radius of the fiber.

The term “up-dopant,” as used herein, refers to a dopant which raises the refractive index of silica glass relative to pure, undoped SiO₂. The term “down-dopant,” as used herein, is a dopant which lowers the refractive index of silica glass relative to pure, undoped SiO₂. An up-dopant may be present in a region of an optical fiber having a negative relative refractive index when accompanied by one or more other dopants which are not up-dopants. Likewise, one or more other dopants which are not up-dopants may be present in a region of an optical fiber having a positive relative refractive index. A down-dopant may be present in a region of an optical fiber having a positive relative refractive index when accompanied by one or more other dopants which are not down-dopants. Likewise, one or more other dopants which are not down-dopants may be present in a region of an optical fiber having a negative relative refractive index.

The term “fully-dense glass” refers to the density of the glass (i.e., glass without pores, voids, etc.) which varies with the composition of the glass. For example, fully-dense glass which is 100% silica glass may have a density of 2.2 g/cm³. In contrast, fully-dense silica glass which is doped with 40 wt. % GeO₂ may have a density of about 2.8 g/cm³.

The term “substantially free,” as used herein, means that the silica-based glass in the corresponding region of the soot preform contains less than 0.1 wt. % of a specified material as either a contaminant or tramp constituent (i.e., the material is not intentionally added to the silica-based glass of that region).

The soot preforms described herein are formed using selective diffusion layers positioned between and/or within distinct regions of the preform in order to control the diffusion of processing agents and/or dopants between the regions. The selective diffusion layer generally has an as-formed density which is sufficiently low to allow for processing agents and/or dopants to diffuse through the selective diffusion layer. However, the as-formed density of the selective diffusion layer is generally greater than the adjacent regions of the preform such that, as the preform is sintered, the selective diffusion layer achieves a barrier density which is greater than the as-formed density thereby preventing further diffusion of the processing agents and/or dopants through the selective diffusion layer. Accordingly, one or more selective diffusion layers within the preform can be used to control the diffusion and migration of various processing agents and/or dopants between regions of the soot preform during manufacture.

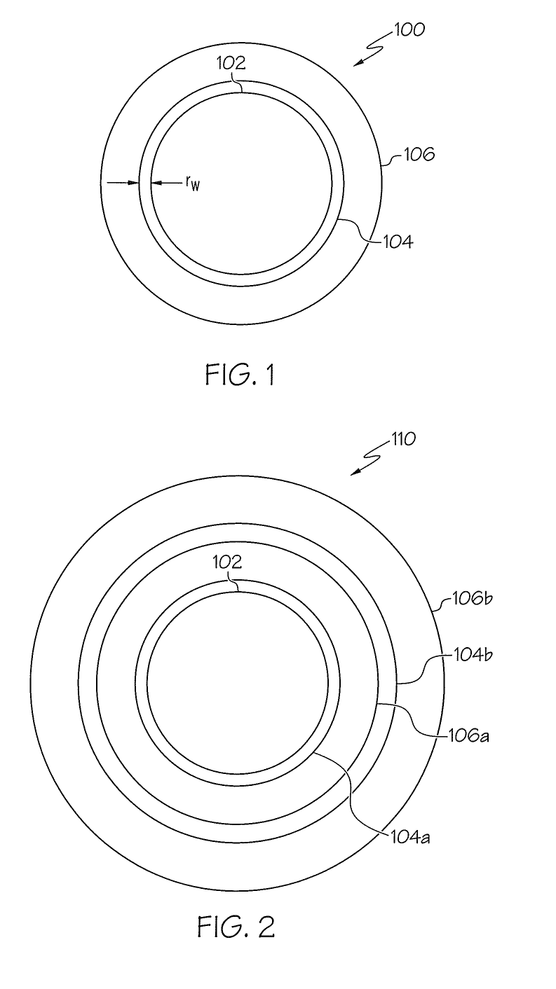

Referring to FIG. 1, a cross section of a soot preform 100 according to one or more embodiments described herein is schematically depicted. In this embodiment, the soot preform 100 generally comprises an inner region which, in this embodiment, is a preform core portion 102, and at least one selective diffusion layer 104. The soot preform 100 may optionally include one or more outer regions, which, in the embodiment shown in FIG. 1, is a cladding portion of the soot preform, specifically an inner cladding layer 106. However, it should be understood that these outer regions are optional and, in some embodiments, the soot preform 100 may be formed without the outer layers, such as when the soot preform 100 is used to produce a core rod assembly. The terms “inner” and “outer,” as used herein, refer to the relative orientation of the specified region with respect to at least one other region and the center of the soot preform. For example, an “inner region” will be positioned radially inward (i.e., towards the center of the soot preform) with respect to an “outer region”.

In the embodiment of the soot preform 100 schematically depicted in FIG. 1, the selective diffusion layer 104 is positioned around the preform core portion 102 such that the selective diffusion layer 104 and the preform core portion 102 are generally circular symmetric with respect to the center of the soot preform 100. In the embodiment of the soot preform 100 depicted in FIG. 1, the selective diffusion layer 104 is in direct contact with the preform core portion 102, such as when the selective diffusion layer 104 is deposited directly on the preform core portion 102. In some embodiments, the selective diffusion layer 104 and the preform core portion 102 may be formed from silica-based glass having the same composition. In these embodiments, the selective diffusion layer 104 may form part of the core portion of the soot preform after the soot preform 100 is sintered and densified to fully dense glass. However, it should be understood that, in other embodiments, the selective diffusion layer 104 may be formed from silica-based glass which has a composition different than that of the preform core portion 102. In still other embodiments (not shown), the selective diffusion layer 104 may be spaced apart from the preform core portion 102 by one or more intermediate layers of silica-based glass soot. In these embodiments, the selective diffusion layer 104 may be a distinct region external to the core portion of the soot preform when the soot preform 100 is sintered and densified to fully dense glass.

In the embodiment depicted in FIG. 1, the preform core portion 102 is formed from silica-based glass soot which includes at least one dopant species for altering the index of refraction of the silica-based glass soot of the preform core portion 102. For example, in some embodiments, the preform core portion 102 includes at least one dopant for increasing the index of refraction of the silica-based glass soot of the preform core portion. Suitable up-dopants for increasing the index of refraction of the core region include, without limitation, GeO₂, Al₂O₃, P₂O₅, TiO₂, ZrO₂, Nb₂O₅, Ta₂O₅, Cl and/or combinations thereof. In some embodiments, the preform core portion 102 may include a combination of up-dopants, such as GeO₂, Al₂O₃, P₂O₅, TiO₂, ZrO₂, Nb₂O₅, Ta₂O₅, Cl and/or combinations thereof, and down-dopants, such as F, B₂O₃, SiF₄, CF₄, C₂F₆ or similar dopants for decreasing the index of refraction of silica glass. In some embodiments described herein, the preform core portion 102 may be suitably doped (or undoped) such that, when the soot preform 100 is sintered and densified to fully dense glass, the preform core portion 102 has a specified refractive index profile including, without limitation, a step index refractive index profile or a graded index profile (i.e., an alpha profile).

The preform core portion is generally formed with an initial preform core density which facilitates the diffusion of one or more diffusing species (such as processing agents and/or dopants) through the preform core portion from outside of the preform core portion. In the embodiments described herein, the preform core portion 102 has a preform core density which is less than the as-formed density of the selective diffusion layer 104. When the preform core portion is formed from relatively pure silica-based glass, the preform core portion 102 may have a preform core density from greater than or equal to about 0.3 g/cm³ to less than or equal to about 0.8 g/cm³ or even 1.0 g/cm³. Alternatively, when the preform core portion is formed from doped silica-based glass, the preform core portion 102 may have a preform core density from greater than or equal to about 0.3 g/cm³ to less than or equal to about 1.0 g/cm³.

Still referring to FIG. 1, the selective diffusion layer 104 is generally formed from silica-based glass soot deposited around the preform core portion 102. In the embodiments described herein, the selective diffusion layer 104 may be formed from relatively pure (i.e., silica-based glass soot which is substantially free of dopants) or from silica-based glass soot which contains one or more dopants for altering the index of refraction of silica glass. For example, in some embodiments, the selective diffusion layer 104 may include at least one dopant for increasing the index of refraction of the silica-based glass soot. Suitable up-dopants include, without limitation, GeO₂, Al₂O₃, P₂O₅, TiO₂, ZrO₂, Nb₂O₅, Ta₂O₅, Cl and/or combinations thereof. In some embodiments, the selective diffusion layer 104 may include a combination of up-dopants, such as GeO₂, Al₂O₃, P₂O₅, TiO₂, ZrO₂, Nb₂O₅, Ta₂O₅, Cl and/or combinations thereof, and down-dopants, such as F, B₂O₃, or similar dopants for decreasing the index of refraction of silica glass. In still other embodiments, the selective diffusion layer 104 may be formed from silica-based glass which includes one or more down dopants, such as F, B₂O₃, SiF₄, CF₄, C₂F₆, or similar down-dopants, such as when the selective diffusion layer 104 is a low-index trench surrounding the preform core portion 102 of the soot preform. Accordingly, in the embodiments described herein, it should be understood that the selective diffusion layer 104 may either be un-doped (i.e., substantially free of dopant), up-doped, or down-doped, depending on the specific designed refractive index profile of optical fibers which will be drawn from the optical fiber preform.

In the embodiments described herein, the selective diffusion layer 104 may have a radial width r_{w} which is generally greater than or equal to about 100 μm. In some embodiments the radial width r_{w} may be less than or equal to 1000 μm. For example, in some embodiments, the radial width r_{w} of the selective diffusion layer 104 may be greater than or equal to 100 μm and less than or equal to 1000 μm. In some other embodiments, the radial width r_{w} of the selective diffusion layer 104 may be greater than or equal to 200 μm and less than or equal to 500 μm.

As noted hereinabove, the as-formed density of the selective diffusion layer 104 (i.e., the density of the selective diffusion layer 104 as it is initially deposited) is generally greater than the preform core portion 102. However, the as-formed density of the selective diffusion layer 104 is sufficiently low to allow one or more diffusing species (such as processing agents and/or dopants) to diffuse through the selective diffusion layer 104 into the preform core portion 102. Further, forming the selective diffusion layer 104 such that the as-formed density of the selective diffusion layer 104 is greater than the preform core density allows the selective diffusion layer 104 to be rapidly densified to a barrier density during sintering of the soot preform. The selective diffusion layer 104 with the barrier density prevents the migration and diffusion of species across the selective diffusion layer 104, thereby preventing the cross contamination of regions adjacent to the selective diffusion layer with species from other regions of the soot preform.

In the embodiments described herein, the selective diffusion layer 104 has a normalized as-formed density greater than or equal to 0.6 and less than or equal to 0.91, preferably greater than or equal to 0.7 and less than or equal to 0.91. In some embodiments, the selective diffusion layer 104 may have a normalized density greater than or equal to 0.81 and less than or equal to 0.91, preferably greater than or equal to 0.81 and less than or equal to 0.86. The phrase “normalized density” refers to the density fraction of fully-dense glass having the same composition of the silica-based glass soot from which the selective diffusion layer 104 is formed (i.e., normalized density=(density of selective diffusion layer prior to sintering)/(the density of fully-dense glass having the same composition)). For example, in some embodiments described herein, the selective diffusion layer 104 may be formed from silica-based glass soot which is substantially free from dopants. Fully-dense silica glass which is free from dopants may have a density of 2.2 g/cm³. In embodiments where the selective diffusion layer is formed from silica-based glass soot which is substantially free from dopants, the selective diffusion layer may have a density from greater than or equal to about 1.3 g/cm³ to less than or equal to 2.0 g/cm³. In some of these embodiments, the selective diffusion layer may have a density from greater than or equal to about 1.5 g/cm³ to less than or equal to 1.9 g/cm³. In some other embodiments, the selective diffusion layer 104 may be formed form silica-based glass soot which is doped with 40 wt. % GeO₂. Fully-dense silica glass doped with 40 wt. % GeO₂ has a density of about 2.8 g/cm³ due to the presence of higher density GeO₂ glass which has a density of 3.6 g/cm³ when fully dense. In embodiments where the selective diffusion layer is formed from silica-based glass soot which is doped with 40 wt. % GeO₂, the selective diffusion layer may have a density from greater than or equal to about 1.68 g/cm³ and less than or equal to 2.55 g/cm³. In some of these embodiments, the selective diffusion layer may have a density from greater than or equal to about 1.8 g/cm³ and less than or equal to 2.55 g/cm³. In still other embodiments, the selective diffusion layer may have a density from greater than or equal to about 1.9 g/cm³ and less than or equal to 2.55 g/cm³.

Still referring to FIG. 1, the soot preform 100 may further comprise one or more cladding layers (i.e., outer regions) deposited around the selective diffusion layer 104 and the preform core portion 102, such as cladding layer 106. The cladding layer 106 may be formed from silica-based glass soot which is substantially free of dopants or which contains one or more dopants for increasing the index of refraction of silica glass and/or one or more dopants for decreasing the index of refraction of silica glass. For example, in some embodiments, the cladding layer may include at least one dopant for decreasing the index of refraction of the silica-based glass soot, such as F, B₂O₃, SiF₄, CF₄, C₂F₆ or similar dopants for decreasing the index of refraction of silica glass. In some embodiments, the cladding layer 106 may include a combination of up-dopants, such as GeO₂, Al₂O₃, P₂O₅, TiO₂, ZrO₂, Nb₂O₅, Ta₂O₅, Cl and/or combinations thereof, and one or more down-dopants. In still other embodiments, the cladding layer 106 may be formed from silica-based glass which includes one or more up-dopants. Suitable up-dopants include, without limitation, GeO₂, Al₂O₃, P₂O₅, TiO₂, ZrO₂, Nb₂O₅, Ta₂O₅, Cl and/or combinations thereof.

When the soot preform 100 includes a cladding layer 106, the cladding layer generally has a cladding density which is less than the as-formed density of the selective diffusion layer 104. This allows at least one diffusing species (such as a processing agent and/or a dopant) to be diffused through the cladding layer 106 and the selective diffusion layer 104 and into the preform core portion 102. When the cladding layer 106 is formed from relatively pure silica-based glass, the cladding layer 106 may have a cladding layer density from greater than or equal to about 0.3 g/cm³ to less than or equal to about 1.0 g/cm³. When the cladding layer 106 is formed from doped silica-based glass, the cladding layer 106 may have a preform core density from greater than or equal to about 0.3 g/cm³ to less than or equal to about 1.2 g/cm³.

While FIG. 1 schematically depicts a soot preform 100 which comprises a selective diffusion layer 104 positioned around the preform core portion 102, it should be understood that selective diffusion layers may be positioned in other regions of the soot preform in order to selectively control the diffusion and migration of dopants and/or processing agents into and out of various regions of the soot preform.

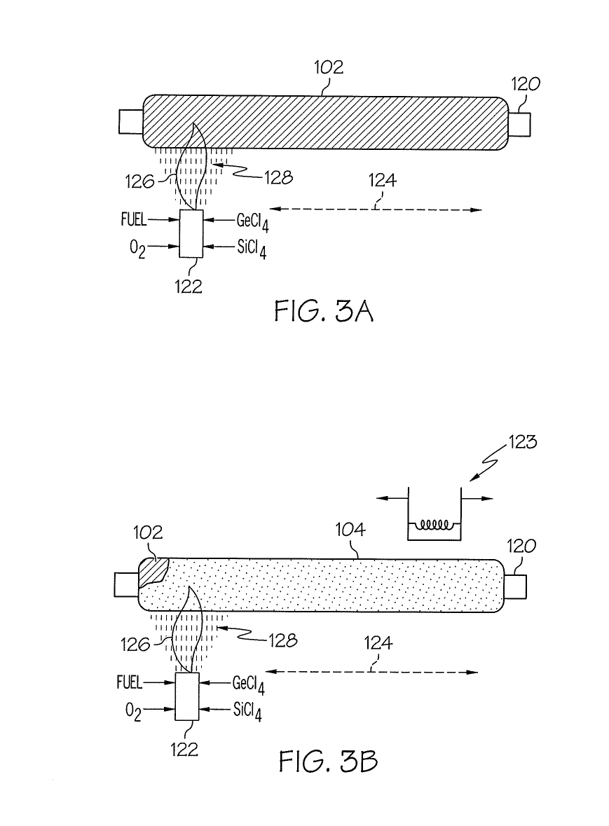

Referring now to FIG. 2 by way of example, an alternative embodiment of a soot preform 110 is schematically depicted. In this embodiment, the soot preform includes a preform core portion 102 which is surrounded by a cladding portion, specifically an inner cladding layer 106a, as described hereinabove with respect to FIG. 1. The preform core portion 102 and inner cladding layer 106a may be formed from the same materials and have the same densities as the preform core portion 102 and cladding layer 106 described hereinabove with respect to FIG. 1. In this embodiment, the soot preform 110 may optionally include an inner selective diffusion layer 104a disposed between the preform core portion 102 and the inner cladding layer 106a, as described above with respect to FIG. 1. The inner selective diffusion layer 104a may be formed from the same materials and have the same density and radial thickness as the selective diffusion layer 104 described hereinabove with respect to FIG. 1. However, while the embodiment of the soot preform 110 is schematically depicted in FIG. 2 as having an inner selective diffusion layer 104a, it should be understood that, in other embodiments, the soot preform 110 may be formed without an inner selective diffusion layer 104a. Further, in some embodiments, the preform core portion may be formed from fully-dense silica-based glass.

Still referring to FIG. 2, in this embodiment of the soot preform 110, the soot preform 110 further includes an outer selective diffusion layer 104b positioned around the inner cladding layer 106a. The outer selective diffusion layer 104b is generally formed from silica-based glass soot deposited around the inner cladding layer 106a. The outer selective diffusion layer 104b may be formed from relatively pure silica glass soot (i.e., silica glass soot substantially free from dopants) or from silica-based glass soot which contains one or more dopants for altering a property of the silica glass, such as the index of refraction of the silica glass, the viscosity of the silica glass, or the like. For example, in some embodiments, the outer selective diffusion layer 104b may include at least one dopant for increasing the index of refraction of the silica-based glass soot. Suitable up-dopants include, without limitation, GeO₂, Al₂O₃, P₂O₅, TiO₂, ZrO₂, Nb₂O₅, Ta₂O₅, Cl and/or combinations thereof. In some embodiments, the outer selective diffusion layer 104b may include a combination of up-dopants, such as GeO₂, Al₂O₃, P₂O₅, TiO₂, ZrO₂, Nb₂O₅, Ta₂O₅, Cl and/or combinations thereof, and down-dopants, such as F, B₂O₃, SiF₄, CF₄, C₂F₆ or similar dopants for decreasing the index of refraction of silica glass. In still other embodiments, the outer selective diffusion layer 104b may be formed from silica-based glass which includes one or more down dopants, such as F, B₂O₃, SiF₄, CF₄, C₂F₆ or similar down-dopants, such as when the outer selective diffusion layer 104b is a low-index trench surrounding the preform core portion 102 of the soot preform. Accordingly, in the embodiments described herein, it should be understood that the outer selective diffusion layer 104b may either be un-doped (i.e., substantially free of dopant), up-doped, or down-doped, depending on the specific designed refractive index profile of optical fibers which will be drawn from the optical fiber preform.

In the embodiments described herein, the outer selective diffusion layer 104b may have a radial width r_{w} which is generally greater than or equal to about 100 μm. In some embodiments the radial width r_{w} may be less than or equal to 1000 μm. For example, in some embodiments, the radial width r_{w} of the outer selective diffusion layer 104b may be greater than or equal to 100 μm and less than or equal to 1000 μm. In some other embodiments, the radial width r_{w} of the outer selective diffusion layer 104b may be greater than or equal to 200 μm and less than or equal to 500 μm.

The as-formed density of the outer selective diffusion layer 104b is sufficiently low to allow one or more diffusing species (such as processing agents and/or dopants) to diffuse through the outer selective diffusion layer 104b and into the inner cladding layer 106a and the preform core portion 102. Further, forming the outer selective diffusion layer 104b such that the as-formed density of the selective diffusion layer 104 is greater than the as-formed density of the preform core portion 102 and the as-formed density of the inner cladding layer 106a allows the outer selective diffusion layer 104b to be rapidly densified to a barrier density during sintering of the soot preform. The outer selective diffusion layer 104b with the barrier density prevents the migration and diffusion of species across the outer selective diffusion layer 104b, thereby preventing the cross contamination of regions adjacent to the selective diffusion layer with species from other regions of the soot preform. For example, the outer selective diffusion layer 104b with the barrier density may prevent the migration and diffusion of species from the inner cladding layer 106a into regions of the soot preform radially outward of the outer selective diffusion layer 104b and/or out of the optical fiber preform.

In the embodiments described herein, the outer selective diffusion layer 104b generally has a density similar to the selective diffusion layer 104 described hereinabove with respect to FIG. 1. Specifically, the outer selective diffusion layer 104b has a normalized as-formed density greater than or equal to 0.6 and less than or equal to 0.91, preferably greater than or equal to 0.7 and less than or equal to 0.91. In some embodiments, the selective diffusion layer 104 may have a normalized density greater than or equal to 0.81 and less than or equal to 0.91, preferably greater than or equal to 0.81 and less than or equal to 0.86. The phrase “normalized density” refers to the density fraction of fully-dense glass having the same composition of the silica-based glass soot from which the outer selective diffusion layer 104b is formed (i.e., normalized density=(density of selective diffusion layer prior to sintering)/(the density of fully-dense glass having the same composition)). For example, in some embodiments described herein, the outer selective diffusion layer 104b may be formed from silica-based glass soot which is substantially free from dopants. Fully-dense silica glass which is free from dopants may have a density of 2.2 g/cm³. In embodiments where the outer selective diffusion layer is formed from silica-based glass soot which is substantially free from dopants, the outer selective diffusion layer may have a density from greater than or equal to about 1.3 g/cm³ and less than or equal to 2.0 g/cm³. In some of these embodiments, the outer selective diffusion layer may have a density from greater than or equal to about 1.5 g/cm³ and less than or equal to 1.9 g/cm³. In some other embodiments, the outer selective diffusion layer 104b may be formed form silica-based glass soot which is doped with 40 wt. % GeO₂. Fully-dense silica glass doped with 40 wt. % GeO₂ has a density of about 2.8 g/cm³ due to the presence of higher density GeO₂ glass which has a density of 3.6 g/cm³ when fully dense. In embodiments where the selective diffusion layer is formed from silica-based glass soot which is doped with 40 wt. % GeO₂, the selective diffusion layer may have a density from greater than or equal to about 1.68 g/cm³ and less than or equal to 2.55 g/cm³. In some of these embodiments, the selective diffusion layer may have a density from greater than or equal to about 1.8 g/cm³ and less than or equal to 2.55 g/cm³. In still other embodiments, the selective diffusion layer may have a density from greater than or equal to about 1.9 g/cm³ and less than or equal to 2.55 g/cm³.

Still referring to FIG. 2, the soot preform 110 may further comprise one or more additional cladding layers deposited around the outer selective diffusion layer 104b, such as outer cladding layer 106b. The outer cladding layer 106b may be formed from silica-based glass soot which is substantially free of dopants or which contains one or more dopants for increasing the index of refraction of silica glass and/or one or more dopants for decreasing the index of refraction of silica glass, as described hereinabove. For example, in some embodiments, the outer cladding layer may include at least one dopant for decreasing the index of refraction of the silica-based glass soot, such as F, B₂O₃, SiF₄, CF₄, C₂F₆ or similar dopants for decreasing the index of refraction of silica glass. In some embodiments, the outer cladding layer 106b may include a combination of up-dopants, such as GeO₂, Al₂O₃, P₂O₅, TiO₂, ZrO₂, Nb₂O₅, Ta₂O₅, Cl and/or combinations thereof, and one or more down-dopants. In still other embodiments, the outer cladding layer 106b may be formed from silica-based glass which includes one or more up-dopants. Suitable up-dopants include, without limitation, GeO₂, Al₂O₃, P₂O₅, TiO₂, ZrO₂, Nb₂O₅, Ta₂O₅, Cl and/or combinations thereof.

When the soot preform 110 includes an outer cladding layer 106b, the outer cladding layer generally has a cladding density which is less than the as-formed density of the outer selective diffusion layer 104b. This allows at least one diffusing species (such as a processing agent and/or a dopant) to be diffused through the outer cladding layer 106b, the outer selective diffusion layer 104b, the inner cladding layer 106a, and the inner selective diffusion layer 104a and into the preform core portion 102. When the outer cladding layer 106b is formed from relatively pure silica-based glass soot, the outer cladding layer 106b may have a cladding layer density from greater than or equal to about 0.3 g/cm³ to less than or equal to about 1.0 g/cm³. Alternatively, when the outer cladding layer 106b is formed from doped silica-based glass, the outer cladding layer 106b may have a preform core density from greater than or equal to about 0.3 g/cm³ to less than or equal to about 1.2 g/cm³.

While FIGS. 1 and 2 schematically depict soot preforms with a single selective diffusion layer (FIG. 1) and two selective diffusion layers (FIG. 2) it should be understood that the soot preforms may be constructed with more than two selective diffusion layers and that the selective diffusion layers may be disposed between adjacent regions of the soot preform or at the edge of the soot preform to control the diffusion and migration of various diffusing species, such as processing agents and the like, between regions of the soot preform.

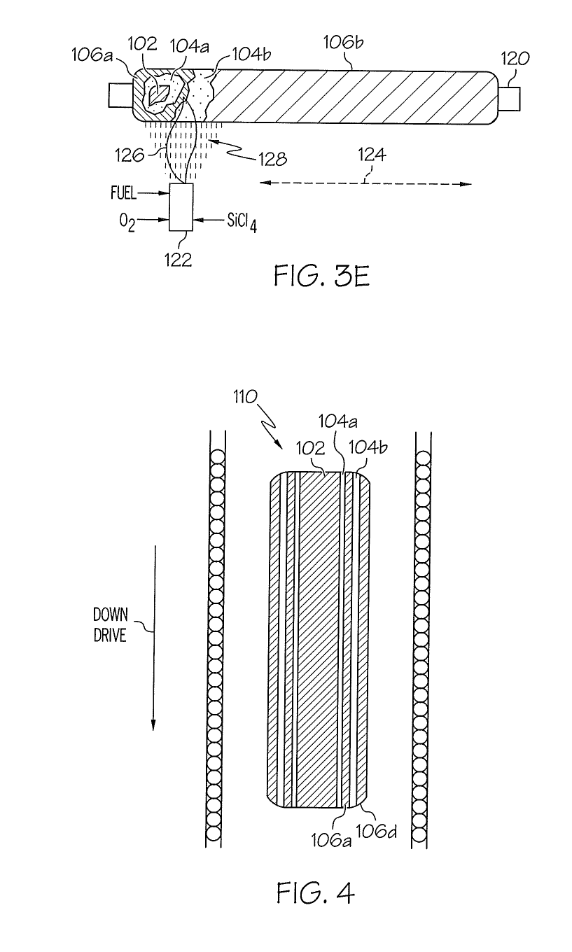

Methods for forming the soot preforms 100, 110 depicted in FIGS. 1 and 2 and consolidating the soot preforms to fully dense glass will now be described in more detail with respect to FIGS. 3A-4. As noted hereinabove, the soot preforms of the embodiments described herein are formed with at least one selective barrier layer by depositing consecutive layers of silica-based glass soot on a bait rod using a vapor deposition process, such as the outside vapor deposition (OVD) process, and controlling the density of the deposited silica glass soot. While the OVD process is used to illustrate one method of forming an optical fiber preform which includes selective diffusion layers, it should be understood that the OVD process is exemplary and that other techniques and combinations of techniques for forming an optical fiber preform with selective diffusion layers may also be used. By way of example and not limitation, one or more of the regions or layers of the optical fiber preform may be formed using soot pressing techniques wherein silica-based glass soot (doped or un-doped) is compacted to a desired density in a mold around one or more inner layers which may likewise be formed by soot pressing. Alternatively, a combination of vapor deposition processes and soot pressing processes may be used to form the optical fiber preform with selective diffusion layers.

Referring to FIG. 3A by way of example, the preform core portion 102 may be formed by depositing silica-based glass soot on a bait rod 120. The silica-based glass soot is formed by providing a vapor-phase, silica-based glass precursor material, such as SiCl₄ or octamethylcyclotetrasiloxane (OMCTS), to a gas-fed burner 122. In embodiments where the preform core portion comprises a dopant for altering the index of refraction of the preform core portion, such as GeO₂ or the like, the dopant precursor materials may likewise be fed to the burner along with the silica-based glass precursor materials. For example, when the preform core portion is formed from GeO₂, the dopant precursor material may be GeCl₄. The gas-fed burner 122 is supplied with fuel, such as CH₄, D₂ (deuterium), or CO, and oxygen which are combusted to create flame 126. Where such a combination (i.e., of fuel and silica-based glass precursor materials) is used to form the silica glass of the selective diffusion layer (described further herein), the interaction between the mode of light propagating in the optical fiber and any residual water in the selective diffusion layer is mitigated. The vapor phase silica-based glass precursor material may be delivered to the burner at a flow rate from about 1 L/min to about 10 L/min while the fuel may be supplied to the burner at a flow rate from about 10 L/min to about 50 L/min or even 60 L/min in order to deposit a preform core portion 102 having the desired density on the bait rod 120.

The vapor phase silica-based glass precursor material and dopant precursor materials are reacted in the flame 126 to produce doped silica-based glass soot 128 which is deposited on the bait rod 120 as the bait rod is rotated at a rate greater than or equal to about 50 rpm and less than or equal to about 400 rpm. The flame 126 of the gas-fed burner 122 is traversed at a first speed back and forth over the axial length of the bait rod 120 as indicated by arrow 124 as the bait rod is rotated thereby building up the doped silica-based glass soot on the bait rod 120 and forming the preform core portion 102. In the embodiments described herein, the traverse rate of the flame 126 is greater than 0.5 cm/s, preferably greater than or equal to 1.5 cm/s or even greater than or equal to 3 cm/s. In the embodiments described herein, the doped silica-based glass soot is deposited on the bait rod 120 such that the preform core portion has a first density which is in the range from greater than or equal to 0.3 g/cm³ and less than or equal to 1.0 g/cm³, preferably less than or equal to 0.8 g/cm³, more preferably less than or equal to 0.7 g/cm³ or even less than or equal to 0.6 g/cm³.

Referring to FIG. 3B, a selective diffusion layer 104 (or inner selective diffusion layer 104a) is formed around the preform core portion 102. Selective diffusion layer 104 generally has an as-formed density which is greater than the preform core density of the preform core portion 102. Specifically, the normalized as-formed density of the selective diffusion layer 104 is generally greater than or equal to 0.6 and less than or equal to 0.91 times the density of fully-dense glass having the same composition.

In one embodiment, the selective diffusion layer 104 is formed from the same precursor materials as the preform core portion 102 (i.e., the selective diffusion layer 104 is formed from silica-based glass soot comprising at least one dopant species). In another embodiment, the flow of the at least one dopant precursor material is reduced or discontinued prior to formation of the selective diffusion layer 104 such that the selective diffusion layer 104 comprises a reduced amount of the at least one dopant species or is substantially free of dopant. In one embodiment, the selective diffusion layer 104 is formed around the preform core portion 102 by increasing a temperature of the flame 126 of the gas-fed burner 122 from the first temperature to a second temperature and decreasing the traverse speed of the flame of the burner from the first speed to a second speed. The temperature of the flame 126 can be increased by increasing the flow rate of the fuel and oxygen supplied to the gas-fed burner 122. In one embodiment, the temperature of the flame 126 of the gas-fed burner 122 is increased from the range of 2000° C.-2400° C. to greater than 2400° C. The traverse speed of the flame of the burner may be decreased from the first speed used to deposit the preform core portion 102 to a second speed which is preferably less than 1 cm/sec, more preferably less than 0.5 cm/sec and, even more preferably, less than 0.25 cm/sec. Increasing the temperature of the flame 126 of the gas-fed burner 122 and decreasing the traverse speed of the flame increases the density of the soot deposited on the bait rod thereby forming a selective diffusion layer with increased density around the preform core portion.

In another embodiment, the selective diffusion layer 104 is formed around the preform core portion 102 by increasing a temperature of the flame 126 of the gas-fed burner 122 from a first temperature to a second temperature and reducing a concentration of the vapor phase silica-based glass precursor materials supplied to the gas-fed burner 122. For example, the flow of silica-based glass precursor materials may be decreased from approximately 1-10 L/min during the deposition of the preform core portion 102 to less than 1 L/min during formation of the selective diffusion layer 104. In one embodiment, the concentration of vapor phase silica-based glass precursor materials is decreased to zero. Reducing the concentration of the silica-based glass precursor material increases the flame temperature and slows or even halts (e.g., when the flow of silica-based glass precursor materials is zero) the deposition of silica-based glass soot over the preform core portion 102. However, increasing the temperature of the flame 126 causes densification of the outer layer of silica-based glass soot of the preform core portion 102 such that the outer layer of silica-based glass soot has a density which is greater than the density of the silica-based glass soot in the remainder of the thickness of the preform core portion 102. This relatively denser layer of soot forms the selective diffusion layer 104. In this embodiment, the temperature of the flame 126 may be increased to 2400° C. or greater in order to densify the outer layer of silica-based glass soot of the preform core portion.

In yet another embodiment, the selective diffusion layer 104 may be formed around the preform core portion 102 by increasing a temperature of the flame 126 of the gas-fed burner 122 from a first temperature to a second temperature and decreasing the traverse speed of the burner from a first speed to a second speed, as described above, while reducing a concentration of the vapor phase silica-based glass precursor materials in the carrier gas supplied to the gas-fed burner 122. As described above, reducing the concentration of the silica-based glass precursor material slows or halts the deposition of silica-based glass soot onto the preform core portion 102, as described above. However, increasing the temperature of the flame 126 and decreasing the traverse speed of the flame 126 densifies the outer layer of silica-based glass soot of the preform core portion 102 such that the outer layer of silica-based glass soot has a density which is greater than the density of the silica-based glass soot in the remainder of the preform core portion. This densified layer of soot forms the selective diffusion layer 104. In this embodiment, the temperature of the flame 126 may be increased to 2400° C. or greater in order to densify the outer layer of silica-based glass soot of the preform core portion. In this embodiment, the traverse speed of the flame 126 is decreased from the first speed used to deposit the preform core portion 102 to a second speed which is preferably less than 1 cm/sec, more preferably less than 0.5 cm/sec and, even more preferably, less than 0.25 cm/sec.

In the aforementioned embodiments, the surface of the preform core portion 102 may be heated with an auxiliary heat source 123, such as a resistance heater or the like, as the selective diffusion layer is formed. The supplemental heating aids in densifying the silica-based glass soot to a density greater than that of the preform core portion 102. The auxiliary heat source 123 may be traversed over the surface of the preform core portion 102 in a similar manner as the gas-fed burner 122. Alternatively, the auxiliary heat source 123 may be fixed in position, such as when the auxiliary heat source extends over the entire axial length of the preform core portion 102.

While in some embodiments described herein the selective diffusion layer 104 is formed by heating deposited silica-based glass soot with a gas-fed burner to densify the soot, it should be understood that, in other embodiments, other heat sources may be used. For example, in an alternative embodiment, a CO₂ laser may be utilized to heat the outer layer of silica-based glass soot of the preform core portion 102 and thereby densify the soot.

Moreover, in some embodiments described herein, it is contemplated that the rate of rotation of the bait rod may be adjusted during formation of the selective diffusion layer 104 in order to achieve a selective diffusion layer having the desired density. Specifically, decreasing the rate of rotation of the bait rod may assist in increasing the density of the selective diffusion layer 104.

Referring now to FIG. 3C, once the selective diffusion layer 104 is formed around the preform core portion 102, a cladding layer 106 (or inner cladding layer 106a) may optionally be deposited around the selective diffusion layer 104. In the embodiments described herein, the cladding layer 106 may be formed in a similar manner as the preform core portion 102. Specifically, vapor phase silica-based glass precursor material, such as SiCl₄ or OMCTS, is supplied to the gas-fed burner 122 and reacted in the flame 126 to form silica-based glass soot which is deposited around the selective diffusion layer 104 as the bait rod is rotated. The flame 126 of the gas-fed burner 122 is traversed at the first speed back and forth over the axial length of the bait rod 120 as indicated by arrow 124 as the bait rod is rotated, as described above, thereby building up silica-based glass soot on the bait rod 120 and forming the cladding layer 106. The silica-based glass soot used to form the cladding layer 106 may be pure silica-based glass soot (i.e., silica-based glass soot which is substantially free from dopants) or silica-based glass soot comprising one or more dopants for increasing the index of refraction of the cladding layer 106.

Referring now to FIG. 3D, once the optional cladding layer 106 is deposited around the preform core portion 102, a second selective diffusion layer (i.e., outer selective diffusion layer 104b) may be optionally deposited around the cladding layer 106. The outer selective diffusion layer 104b may be deposited in a similar manner as described above with respect to the selective diffusion layer 104. Specifically, the outer selective diffusion layer 104b may be formed around the cladding layer 106 by increasing a temperature of the flame 126 of the gas-fed burner 122 from the first temperature to a second temperature and decreasing the traverse speed of the flame of the burner from the first speed to a second speed. The temperature of the flame 126 can be increased by increasing the flow rate of the fuel and oxygen supplied to the gas-fed burner 122. In one embodiment, the temperature of the flame 126 of the gas-fed burner 122 is increased from the range of 2000° C.-2400° C. to greater than 2400° C. The traverse speed of the flame of the burner may be decreased from the first speed used to deposit the cladding layer 106 to a second speed which is preferably less than 1 cm/sec, more preferably less than 0.5 cm/sec and, even more preferably, less than 0.25 cm/sec. Increasing the temperature of the flame 126 of the gas-fed burner 122 and decreasing the traverse speed of the flame increases the density of the soot deposited on the bait rod thereby forming a selective diffusion layer with increased density around the cladding layer 106.

In another embodiment, the outer selective diffusion layer 104b is formed around the cladding layer 106 by increasing a temperature of the flame 126 of the gas-fed burner 122 from a first temperature to a second temperature and reducing a concentration of the vapor phase silica-based glass precursor materials supplied to the gas-fed burner 122. For example, the flow of silica-based glass precursor materials may be decreased from approximately 1-10 L/min during the deposition of the cladding layer 106 to less than 1 L/min during formation of the outer selective diffusion layer 104b. In one embodiment, the concentration of vapor phase silica-based glass precursor materials is decreased to zero. Reducing the concentration of the silica-based glass precursor material increases the flame temperature and slows or even halts (e.g., when the flow of silica-based glass precursor materials is zero) the deposition of silica-based glass soot over the cladding layer 106. However, increasing the temperature of the flame 126 causes densification of the outer layer of silica-based glass soot of the cladding layer 106 such that the outer layer of silica-based glass soot has a density which is greater than the density of the silica-based glass soot in the remainder of the thickness of the cladding layer 106. This relatively denser layer of soot forms the outer selective diffusion layer 104b. In this embodiment, the temperature of the flame 126 may be increased to 2400° C. or greater in order to densify the outer layer of silica-based glass soot of the cladding layer 106.

In yet another embodiment, the outer selective diffusion layer 104b may be formed around the cladding layer 106 by increasing a temperature of the flame 126 of the gas-fed burner 122 from a first temperature to a second temperature and decreasing the traverse speed of the burner from a first speed to a second speed, as described above, while reducing a concentration of the vapor phase silica-based glass precursor materials in the carrier gas supplied to the gas-fed burner 122. As described above, reducing the concentration of the silica-based glass precursor material slows or halts the deposition of silica-based glass soot onto the cladding layer 106, as described above. However, increasing the temperature of the flame 126 and decreasing the traverse speed of the flame 126 densifies the outer layer of silica-based glass soot of the cladding layer 106 such that the outer layer of silica-based glass soot has a density which is greater than the density of the silica-based glass soot in the remainder of the cladding layer 106. This densified layer of soot forms the outer selective diffusion layer 104b. In this embodiment, the temperature of the flame 126 may be increased to 2400° C. or greater in order to densify the outer layer of silica-based glass soot of the cladding layer 106. In this embodiment, the traverse speed of the flame 126 is decreased from the first speed used to deposit the cladding layer 106 to a second speed which is preferably less than 1 cm/sec, more preferably less than 0.5 cm/sec and, even more preferably, less than 0.25 cm/sec.

Referring now to FIG. 3E, once the outer selective diffusion layer 104b is formed around the cladding layer 106, a second cladding layer (i.e., outer cladding layer 106b) may optionally be deposited around the outer selective diffusion layer 104b. In the embodiments described herein, the outer cladding layer 106b may be formed in a similar manner as the preform core portion 102 and the cladding layer 106. Specifically, vapor phase silica-based glass precursor material, such as SiCl₄ or OMCTS, is supplied to the gas-fed burner 122 and reacted in the flame 126 to form silica-based glass soot which is deposited around the outer selective diffusion layer 104b as the bait rod is rotated. The flame 126 of the gas-fed burner 122 is traversed at the first speed back and forth over the axial length of the bait rod 120 as indicated by arrow 124 as the bait rod is rotated, as described above, thereby building up silica-based glass soot on the bait rod 120 and forming the outer cladding layer 106b. The silica-based glass soot used to form the cladding layer 106 may be pure silica-based glass soot (i.e., silica-based glass soot which is substantially free from dopants) or silica-based glass soot comprising one or more dopants for increasing the index of refraction of the outer cladding layer 106b.

Once the various portions of the soot preform have been formed on the bait rod, the bait rod is removed from the soot preform. Thereafter, the soot preform is further treated by diffusing at least one diffusing species through the selective diffusion layers and cladding layers and into the core portion of the soot preform. The at least one diffusing species may be a processing agent or a dopant. For example chlorine gas or SiCl₄ may be used as either drying agents and/or as dopants. In some embodiments, the at least one diffusing species may include, without limitation, of chlorine, SiCl₄, CO, SiF₄, GeCl₄, SOCl₂, CF₄, C₂F₆, D₂O, and H₂O. However, it should be understood that other processing agents and/or dopants may be used as the diffusing species. In some embodiments, the diffusing species may be provided in a gaseous or vapor form. In some other embodiments, the diffusing species may be entrained in a diluent gas, such as nitrogen, helium, argon or a similar diluent gas.

In one particular embodiment, the diffusing species is a drying agent such as chlorine gas. The soot preform is suspended in a flow of the chlorine gas at elevated temperatures to remove water from the various regions of the preform. In one embodiment, the drying agent comprises a mixture of 1% to 10% or even 2% to 6% chlorine gas in a diluent gas such as helium, argon, nitrogen or a similar diluent gas. The soot preform is positioned in a stream of the mixture flowing at a flow rate of about 1 L/min to about 40 L/min as the soot preform 110 is heated to a temperature from about 800° C. to about 1200° C. for a period of up 1-10 hours. Due to the relatively low density of the cladding layers, selective diffusion layers, and preform core portion, the chlorine gas diffuses through the outer cladding layer, the outer selective diffusion layer, the inner cladding layer, the inner selective diffusion layer, and the preform core portion, thereby uniformly drying the entire soot preform.

Referring now to FIG. 4, thereafter, the soot preform 110 is consolidated and sintered to fully dense glass under conditions which prevent the diffusion and migration of the at least one dopant species from the preform core portion of the soot preform. Specifically, the soot preform is positioned in a consolidation furnace and heated to sinter the glass soot into fully dense glass. Because the selective diffusion layers 104a, 104b have densities greater than the adjacent regions of the soot preform 110, the selective diffusion layers 104a, 104b are rapidly consolidated and sintered (i.e., densified) to a barrier density which prevents the migration and/or diffusion of volatilized species through the selective diffusion layers 104a, 104b. For example, in some embodiments described herein, the at least one dopant in the preform core portion 102 is GeO₂. GeO₂ begins to volatilize as the soot preform is heated to the sintering and consolidation temperatures. However, because the selective diffusion layers 104a, 104b rapidly reach a barrier density during sintering, the volatilized GeO₂ is prevented from migrating and diffusion out of the preform core portion 102 of the soot preform, thereby preventing contamination of adjacent regions of the preform.

In the embodiments described herein, the barrier density of the selective diffusion layers 104a, 104b is generally greater than the as-formed density. Specifically, the barrier density of the selective diffusion layers 104a, 104b is generally greater than 0.91 times the density of fully-dense glass having the same composition. For example, in embodiments where the selective diffusion layers are formed from silica-based glass soot which is free from dopants, the barrier density is greater than or equal to 2.0 g/cm³. Similarly, in embodiments where the selective diffusion layers are formed from silica-based glass soot doped with 40 wt. % GeO₂, the barrier density is greater than or equal to about 2.55 g/cm³. In the embodiments described herein, the selective diffusion layers achieve a barrier density at temperatures less than or equal to 1325° C. In some embodiments, the selective diffusion layers achieve a barrier density at temperatures less than or equal to 1300° C. Some other embodiments, the selective diffusion layers achieve a barrier density at temperatures less than or equal to 1275° C. In still other embodiments, the selective diffusion layers achieve a barrier density at temperatures less than or equal to 1250° C.

In order to sinter the soot preform such that the selective diffusion layers 104a, 104b reach a barrier density and prevent the diffusion of the at least one dopant species through the selective diffusion layers, the soot preform 110 is generally heated to the sintering temperature (i.e., from about 1400° C. to about 1550° C.) at a rate a rate greater than or equal to 1° C./min and less than or equal to 20° C./min or even less than or equal to 15° C./min. In some embodiments, the soot preform may be heated to the sintering temperature at a rate a rate greater than or equal to 1° C./min and less than or equal to 10° C./min. For example, in one embodiment, the soot preform is sintered by positioning the soot preform in a heating zone of a consolidation furnace and moving at least one of the preform assembly and the heating zone relative to the other (e.g., down driving) at an apparent traverse rate greater than or equal to about 2 mm/min and less than or equal to about 50 mm/min. The heating zone generally has a temperature greater than or equal to about 1400° C. and less than or equal to about 1550° C. In some embodiments, the apparent traverse rate maybe greater than or equal to 5 mm/min and less than or equal to 20 mm/min. Following the sintering, the soot preform is a fully dense, solid glass optical fiber preform.

In some embodiments described herein at least one second diffusing species may be diffused into the soot preform after the selective diffusion layers have reached a barrier density but prior to the remainder of the soot preform being consolidated to fully dense glass. For example, in some embodiments, a dopant gas may be introduced into the consolidation furnace at temperatures greater than or equal to 1250° C. in order to dope the outer cladding layer of the soot preform after the outer selective diffusion layer reaches barrier density. The at least one second diffusing species may include, without limitation, SiCl₄, CO, SiF₄, GeCl₄, SOCl₂, CF₄, or C₂F₆. The outer selective diffusion layer 104b having achieved a barrier density prevents the migration of the at least one second diffusing species into the inner cladding layer 106a and the preform core portion of the soot preform 100.

### EXAMPLES

The embodiments described herein will be further clarified by the following example.

### Example 1

Two optical fiber preforms were formed, one without a selective diffusion layer positioned around the preform core portion and one with a selective diffusion layer positioned around the preform core portion. The preform core portions of both optical fiber preforms comprised SiO₂ up-doped with GeO₂ and were formed by depositing doped silica glass soot on a bait rod. Specifically, GeO₂ and SiO₂ precursors (GeCl₄ and SiCl₄, respectively) were reacted in the flame of a gas-fed burner fueled by CH₄ and O₂. The resultant doped silica-based glass soot was deposited on a bait rod such that the preform core portion of each preform had an as-formed density of approximately 0.6 g/cm³. Thereafter, a selective diffusion layer was formed around the preform core portion of one of the optical fiber preforms. The selective diffusion layer was formed from silica-based glass soot substantially free of dopants. The selective diffusion layer was formed with a greater density than the preform core portion by temporarily increasing the CH₄ and O₂ fuel flows to the gas-fed burner. This resulted in a selective diffusion layer having an as-formed density of 1.9 g/cm³. The radial thickness of the selective diffusion layer was approximately 200 microns.

A preform cladding layer was then formed around the selective diffusion layer of one of the optical fiber preforms and around the preform core portion of the other optical fiber preform. The preform cladding layer of both preforms was formed from silica-based glass which was substantially free of dopants. The preform cladding layer of each optical fiber preform had as-formed densities of approximately 0.6 g/cm³.

The optical fiber preforms were dried by heating the optical fiber preforms in a furnace at a temperature of 1100° C. for several hours. Chlorine gas was introduced into the furnace muffle in a carrier gas and allowed to diffuse into the soot preforms from the outside surface, thus penetrating the entire volume of the optical fiber preforms, thereby removing the hydroxyl in the soot and chemically drying the optical fiber preforms to ensure low attenuation. After the drying step, the preforms were sintered by moving the preforms axially through a hot zone of a furnace, heating the preforms to 1500° C., thereby sintering the optical fiber preforms. For the optical fiber preform with the selective diffusion layer, the higher density soot of the selective diffusion layer became fully dense, reaching a closed pore state where the density of the silica glass was about 2.1 g/cm³, as the selective diffusion layer reached a temperature of approximately 1325° C. The densification of the selective diffusion layer occurred in advance of the densification of the adjacent preform core portion and the preform cladding layer which comprise lower density soot.

In both preforms, as the sintering front moved radially inward, the GeO₂ in the preform core portion thermally decomposed (i.e., volatilized) and formed gaseous GeO. The gaseous GeO diffused through the pores of the lower density soot of the preform core portion, moving outside of the preform core portion of the optical fiber preform formed without the selective diffusion layer. However, as the GeO diffused radially outwards in the optical fiber preform formed with the selective diffusion layer, the diffusion path was blocked as the density of the selective diffusion layer approached that of solid glass and the GeO remained confined to the preform core portion forming a small accumulation “shelf” radially inward of the selective diffusion layer.

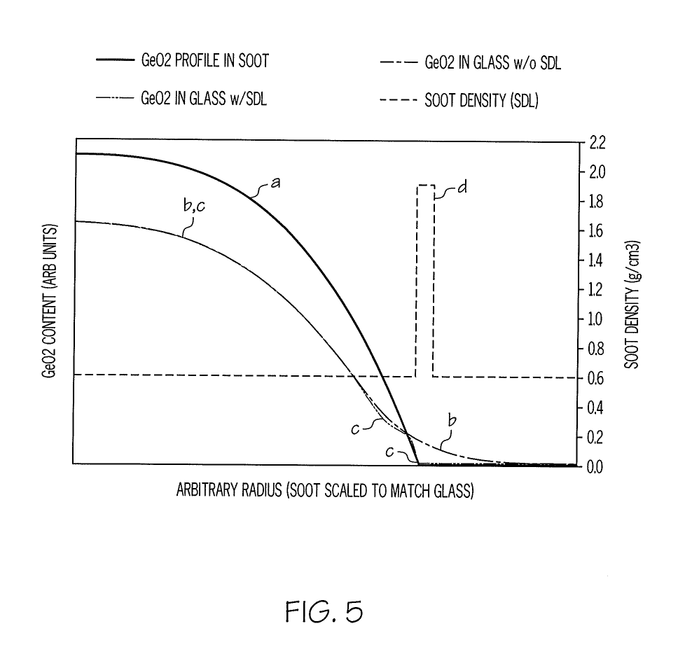

Specifically, FIG. 5 graphically depicts the radius of the optical fiber preforms from the centerline (x-axis); the GeO₂ concentration of the optical fiber preforms (left y-axis) (a) prior to sintering, (b) after sintering without a selective diffusion layer, and (c) after sintering with a selective diffusion layer; and (d) the density of the optical fiber preform with a selective diffusion layer (right y-axis) prior to sintering. As shown in FIG. 5, the concentration of GeO₂ in the optical fiber preforms prior to sintering (i.e., curve (a)) had an index profile which, in these examples, was an alpha-type profile. As the optical fiber preforms were sintered, some diffusion of the GeO₂ in the preform core portion occurred, as shown by both curves (b) and (c). Specifically, the concentration of GeO₂ in the center of the preform core portion was substantially the same for optical fiber preforms formed without a selective diffusion layer (curve (b)) and with a selective diffusion layer (curve (c)). However, at the edge of the preform core portion, the GeO₂ concentration curves deviate from one another. For the optical fiber preform formed without a selective diffusion layer, GeO₂ diffusion created a “diffusion tail” beyond the preform core portion, as indicated by curve (b). However, for optical fiber preforms formed with a selective diffusion layer (i.e., curve (c)), the increased density of the selective diffusion layer (as indicated prior to sintering by curve (d)) prevented substantial diffusion of GeO₂ beyond the preform core portion resulting in a significantly reduced diffusion tail, as indicated by curve (c). This reduced diffusion tail produced more favorable optical properties in the resultant optical fibers drawn from the optical fiber preform with the selective diffusion layer.

It should now be understood that the soot preforms described herein are formed using selective diffusion layers formed between and/or within distinct regions of the preform in order to control the diffusion of processing agents and/or dopants between the regions. For example, a first, inner region of a soot preform may be deposited and a selective diffusion layer formed on or in the first, inner region. Thereafter, a second, outer region may be formed around the selective diffusion layer. The selective diffusion layer generally has an as-formed density which is sufficiently low to allow for processing agents and/or dopants to diffuse through the selective diffusion layer (i.e., from the inner region to the outer region and vice-versa) and thereby diffuse throughout the entire interior volume of the soot preform. However, the as-formed density of the selective diffusion layer is generally greater than the adjacent regions of the soot preform such that, as the preform is sintered, the selective diffusion layer achieves a barrier density which is greater than the as-formed density thereby preventing further diffusion of the processing agents and/or dopants between adjacent regions through the selective diffusion layer. Accordingly, selective diffusion layers within the preform can be used to control the diffusion and migration of various processing agents and/or dopants between regions of the soot preform during manufacture.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A method for forming an optical fiber preform, the method comprising:
forming a preform core portion from silica-based glass soot such that the preform core portion has a preform core density, wherein the silica-based glass soot comprises at least one dopant species for altering an index of refraction of the preform core portion;
forming a selective diffusion layer of silica-based glass soot around the preform core portion to form a soot preform comprising the preform core portion and the selective diffusion layer, wherein the selective diffusion layer has an as-formed density greater than the preform core density;
diffusing at least one diffusing species through the selective diffusion layer into the preform core portion; and
sintering the soot preform such that the selective diffusion layer has a barrier density which is greater than the as-formed density such that the selective diffusion layer prevents diffusion of the at least one dopant species through the selective diffusion layer.

2. The method of claim 1, wherein the selective diffusion layer has a normalized as-formed density greater than or equal to 0.6 and less than or equal to 0.91.

3. The method of claim 1, wherein the selective diffusion layer consists essentially of silica and the as-formed density of the selective diffusion layer is greater than or equal to about 1.3 g/cm³ and less than or equal to about 2.0 g/cm³.

4. The method of claim 1, wherein the barrier density is greater than about 2.0 g/cm³.

5. The method of claim 1, wherein the selective diffusion layer comprises doped silica and the as-formed density of the selective diffusion layer is greater than or equal to about 1.68 g/cm³ and less than or equal to about 2.55 g/cm³.

6. The method of claim 1, wherein the barrier density is greater than about 2.55 g/cm³.

7. The method of claim 1, wherein the selective diffusion layer has a radial thickness greater than or equal to 100 μm.

8. The method of claim 1, wherein the selective diffusion layer comprises the at least one dopant species.

9. The method of claim 1, wherein the selective diffusion layer is substantially free of dopant.

10. The method of claim 1, wherein the at least one dopant species comprises GeO₂.

11. The method of claim 1, wherein the at least one diffusing species comprises at least one of chlorine, SiCl₄, CO, SiF₄, GeCl₄, SOCl₂, CF₄, C₂F₆, D₂O, and H₂O.

12. The method of claim 1, wherein the soot preform is sintered by heating the soot preform at a rate greater than or equal to 1° C./min and less than or equal to 10° C./min.

13. The method of claim 1, wherein the soot preform is sintered by positioning the soot preform in a heating zone and moving at least one of the soot preform and the heating zone relative to the other at an apparent traverse rate greater than or equal to about 2 mm/min and less than or equal to about 50 mm/min, wherein the heating zone has a temperature greater than or equal to about 1400° C. and less than or equal to about 1550° C.

14. The method of claim 1, wherein:
the preform core portion is formed by reacting silica-based glass precursor materials and at least one dopant precursor material in a flame of a gas-fed burner as the flame is traversed over a bait rod in an axial direction; and
the selective diffusion layer is formed by increasing a flow rate of a fuel-oxygen mixture to the flame of the gas-fed burner thereby increasing a temperature of the flame.

15. The method of claim 1 further comprising forming an inner cladding layer around the selective diffusion layer prior to diffusing the at least one diffusing species through the selective diffusion layer, wherein the inner cladding layer has an inner cladding density which is less than the as-formed density of the selective diffusion layer.

16. The method of claim 15, further comprising:
forming an outer selective diffusion layer of silica-based glass soot around the inner cladding layer prior to diffusing the at least one diffusing species through the selective diffusion layer, wherein the outer selective diffusion layer has an outer as-formed density greater than the preform core density and the inner cladding density;
forming an outer cladding layer around the outer selective diffusion layer, wherein the outer cladding layer has an outer cladding density which is less than the outer as-formed density of the outer selective diffusion layer; and
diffusing at least one second diffusing species into the outer cladding layer after the outer selective diffusion layer reaches an outer barrier density during sintering thereby preventing diffusion of the at least one second diffusing species through the outer selective diffusion layer.

17. The method of claim 16, wherein the at least one second diffusing species comprises at least one of chlorine, SiCl₄, CO, SiF₄, GeCl₄, SOCl₂, CF₄, C₂F₆, D₂O, and H₂O.

18. A method for forming an optical fiber preform, the method comprising:
constructing a soot preform by:
forming a preform core portion;
forming an inner cladding layer around the preform core portion, wherein the inner cladding layer has an inner cladding density;
forming an outer selective diffusion layer around the inner cladding layer, wherein the outer selective diffusion layer has an outer as-formed density greater than the inner cladding density; and
forming an outer cladding layer around the outer selective diffusion layer, wherein the outer cladding layer has an outer cladding density which is less than the outer as-formed density;
diffusing at least one diffusing species through the outer selective diffusion layer into the inner cladding layer; and
sintering the soot preform such that the outer selective diffusion layer has an outer barrier density greater than the outer as-formed density and the outer selective diffusion layer prevents diffusion of the at least one diffusing species through the outer selective diffusion layer.

19. The method of claim 18, further comprising diffusing at least one second diffusing species into the outer cladding layer after the outer selective diffusion layer reaches the outer barrier density during sintering thereby preventing diffusion of the at least one second diffusing species through the outer selective diffusion layer.

20. The method of claim 18, wherein the preform core portion comprises an inner selective diffusion layer.
